(19) United States
(12) Patent Application Publication
(10) Pub. No.: US 2009/0132072 A1
(43) Pub. Date: May 21, 2009

(54) Media Player

(76) Inventor: Clark ANGUS, Bristol (GB)

Correspondence Address: BARNES & THORNBURG LLP, 750-17TH STREET NW, SUITE 900, WASHINGTON, DC, 20006-4675, US

(21) Appl. No.: 11/917,301

(22) PCT Filed: Jun. 8, 2006
(86) PCT No.: PCT/GB2006/002094

§ 371 Date: Dec. 12, 2007

(30) Foreign Application Priority Data
Jun. 14, 2005 (GB) 0512110.8

(51) Int. Cl. G06F 17/00; G06F 17/30; G06F 7/06

(52) U.S. Cl. 700/94; 707/104.1; 707/5; 707/E17.044; 707/E17.014

(57) ABSTRACT

A method of assigning a popularity rating to a media recording. A play instruction is generated in response to movement of a switch into an ON position and media playback is started. A stop instruction is generated in response to movement of the switch into an OFF position and the playback is stopped. A play duration indicative of the time lapse between receipt of the play instruction and receipt of the stop instruction is recorded; and a popularity rating assigned to the media recording in accordance with the play duration. A method of selecting and playing a media recording. Play histories are assigned to two or more media recordings, the play histories recording the order in which the media recording were last played. Probability values are assigned to the media recordings at least partially in accordance with their play histories. The probability of selection of each recording is determined by its probability value.

The present invention provides in its various aspects a method and apparatus for assigning a popularity rating to a media recording; selecting and playing a media recording; and controlling a media player. The invention is principally, although not exclusively, used in a system for playing media recordings in response to control instructions received from a baby.

U.S. Pat. No. 6,160,986 describes an interactive toy, in the general form of a doll, which includes a number of input sensors and a variety of output actuators. A two-unit design is described in which the doll communicates with a computerised base-unit over RF. The base-unit is responsible for collecting and storing sensor inputs, and delivering content to the doll. The base-unit can implement a number of predetermined content branches based on the current and past values of the sensor inputs. The patent goes on to suggest an authoring system whereby users can design their own interactive story.

The device presented in U.S. Pat. No. 4,819,616 generates a soothing random noise, similar to white noise. A microphone is used to detect when the baby starts crying. Initially a burst of noise is used to attract the attention of the baby. Shortly afterwards, the intensity of the noise reduces and continues to play until a predefined period of time. It is claimed that the noise generated by the system helps to induce sleep.

U.S. Pat. No. 5,774,861 describes a sound activated cot mounted device. When crying is detected, the device illuminates a picture of the baby's mother and plays an audio message. The device also includes a facility for the mother to record her own message.

U.S. Pat. No. 6,692,330 relates to a cot mounted device which plays audio recordings. The device can be activated manually by the parent, or when crying is detected. Storage for a number of different recordings is available. The parent can select which one of the recordings should be selected for use. Additionally, the device offers the facility for the parent to record their own material.

U.S. Pat. No. 6,116,983 describes a cot mounted toy for playing a number of different sounds. Activation and selection of the sound is controlled by the parent via a remote unit.

U.S. Pat. No. 6,022,262 describes an audio playback device for use in a cot. Playback commences when a handle is pulled and ceases when the handle is released. The device stores a number of different sounds and audio recordings. The parent selects manually which of the sounds should be played. The device also includes a facility for the parent to record their own message.

A first aspect of the invention provides a method of assigning a popularity rating to a media recording, the method comprising generating a play instruction in response to movement of a switch into an ON position; starting playback of the media recording in response to the play instruction; generating a stop instruction in response to movement of the switch into an OFF position; stopping playback of the media recording in response to the stop instruction; recording a play duration indicative of the time lapse between receipt of the play instruction and receipt of the stop instruction; and assigning a popularity rating to the media recording at least partially in accordance with the play duration.

The first aspect enables a popularity rating to be assigned on the basis of crude stop/start instructions generated by a simple ON/OFF switch. This makes it particularly suited to use with a baby. The popularity rating may consist of the raw play duration data, or may be a more sophisticated parameter based for example on a play pattern associated with the media recording.

The media recording may contain sound and/or vision, although in the preferred embodiment described below the media recording contains only sound.

A second aspect of the invention provides a method of selecting and playing a media recording, the method comprising assigning play histories to two or more media recordings, the play histories recording the order in which the media recordings were last played; assigning probability values to the media recordings at least partially in accordance with their play histories; selecting one of the media recordings, the probability of selection of each recording being determined by its probability value; playing the selected media recording; and assigning a new play history to the selected media recording.

The second aspect provides a selection method which enables the probability of selection of individual recordings to be adjusted according to their play history.

The play histories may be recorded in a number of ways. For instance the play histories may be assigned to the media recordings by maintaining an ordered list of the two or more media recordings, ordered by when the media recording was last played; and the probability values are assigned to the media recordings at least partially in accordance with their position in the list. Alternatively, instead of maintaining an ordered list, the play history may be recorded by associating an index with each media recording (the index being equivalent to the position of the recording in an ordered list).

A third aspect of the invention provides a method of controlling a media player, the method comprising receiving a control instruction; transmitting a series of control signals in response to the control instruction over an air interface to a media player, wherein the duration between adjacent pairs of control signals increases over the course of the series; and terminating the transmission of the series of control signals in response to a termination condition.

The control instruction may be a play instruction, a stop instruction, or any other instruction intended to control the media player.

A fourth aspect of the invention provides a method of selecting and playing a media recording, the method comprising:
a) selecting a media recording from a set of media recordings;
b) playing the selected media recording;
c) adding a new media recording to the set in response to step a) or step b); and
d) repeating steps a)-c).

The fourth aspect prevents a baby from being immediately “bombarded” with a wide variety of recordings, but instead introduces them in a more gradual manner.

A fifth aspect of the invention provides a method of controlling a media player, the method comprising receiving a control instruction from a pull-cord operated switch; and transmitting a control signal over an air interface to a media player in response to receipt of the control instruction.

The pull-cord operated switch is particularly suited for use by a baby, and the air interface means that control and/or power cords are not required near the baby, or its cot/crib. The control instruction may be a play instruction, a stop instruction, or any other instruction intended to control the media player.

A sixth aspect of the invention provides a method of controlling a media player, the method comprising receiving a control instruction from a switch mounted to a cot or crib; and transmitting a control signal over an air interface to a media player in response to receipt of the control instruction.

The cot/crib-mounted switch is particularly suited for use by a baby, and the air interface means that control and/or power cords are not required near the baby, or its cot/crib. The control instruction may be a play instruction, a stop instruction, or any other instruction intended to control the media player.

Any suitable mounting device may be used, typically employing a screw mechanism. Preferably the mechanism comprises a threaded support member sized to fit between a pair of upright bars; and a threaded locking member which can be screwed onto the support member and has a width greater than the distance between the upright bars.

A preferred embodiment of the present invention will now be described with reference to the accompanying drawings, in which:

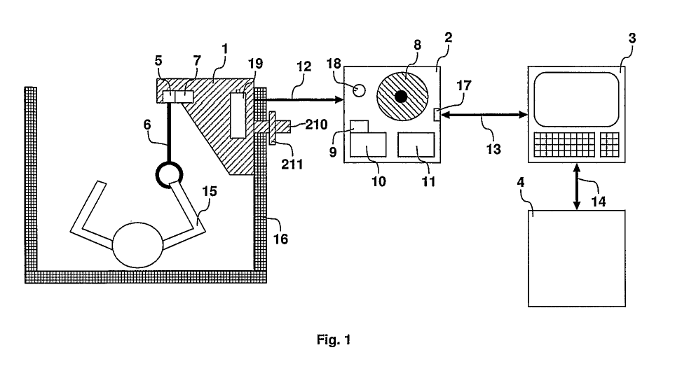

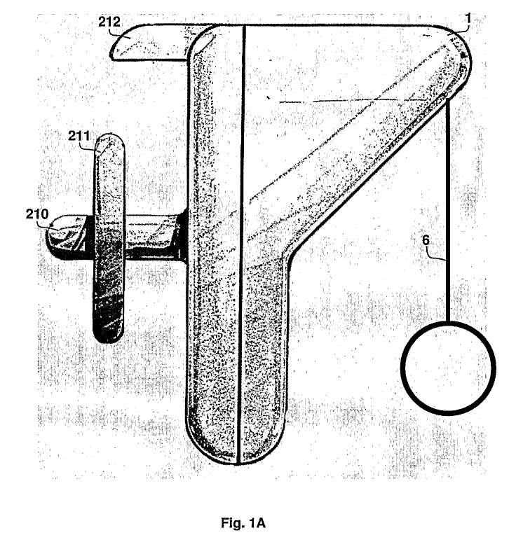

FIG. 1 is a schematic overview of the system;

FIG. 1A shows a cross section of the cot unit;

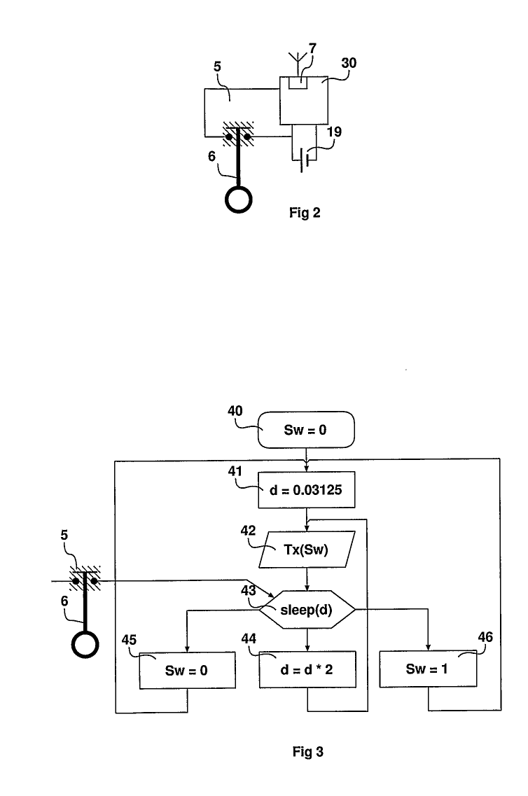

FIG. 2 is a schematic view of the cot unit;

FIG. 3 shows the switch protocol operation;

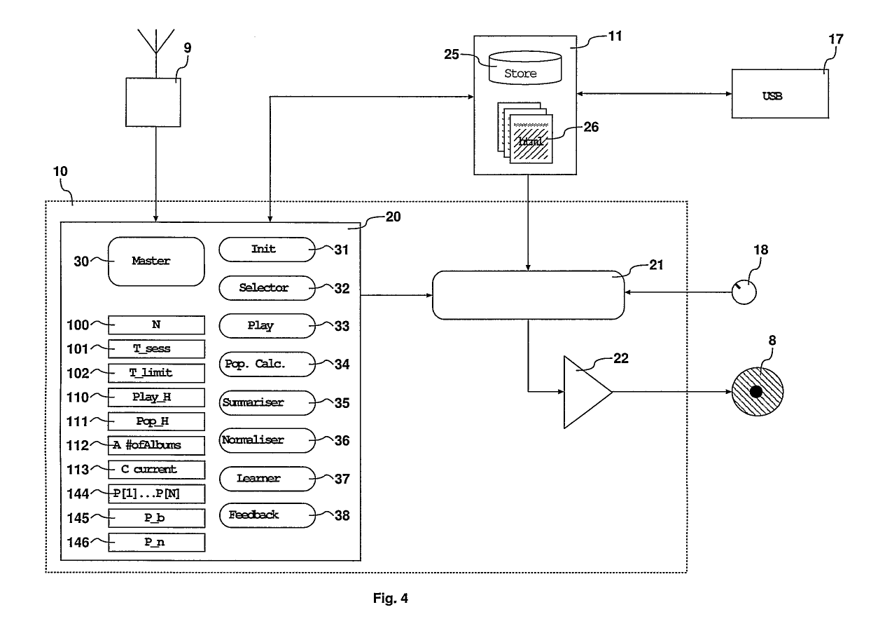

FIG. 4 is a schematic view of the base unit;

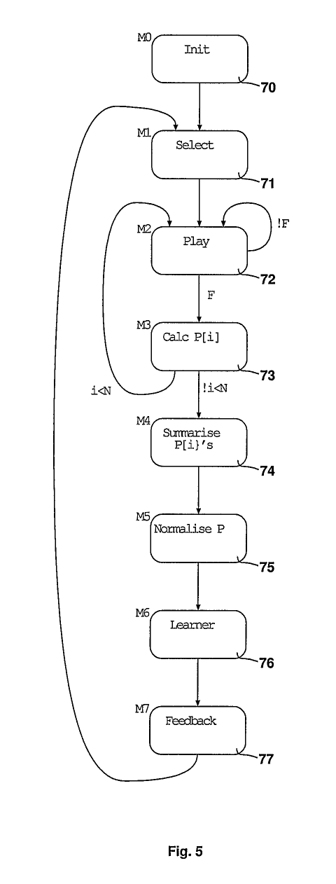

FIG. 5 shows the general flow of control by the master controller;

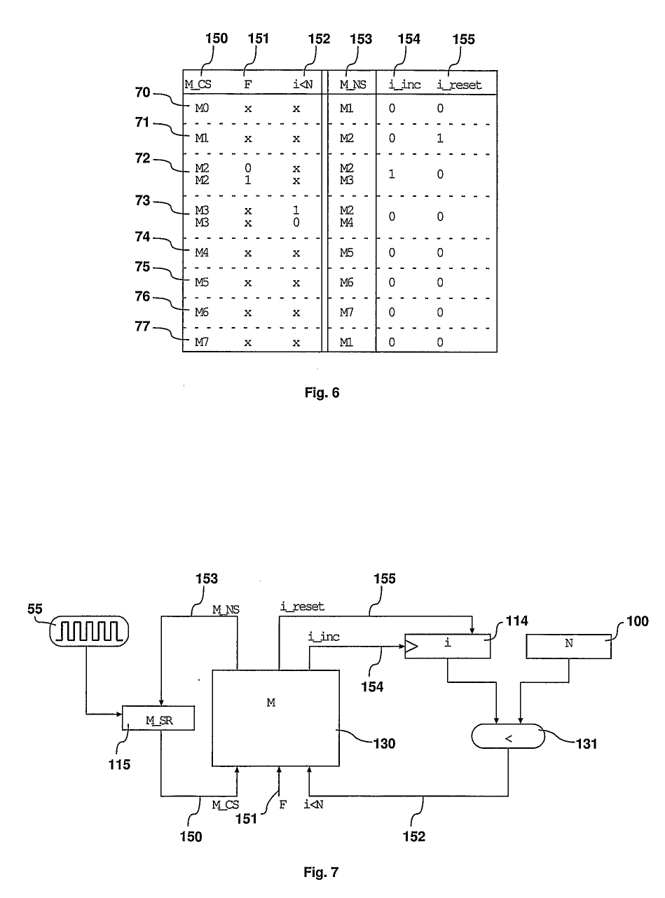

FIG. 6 is a state-table denoting the states of the master controller;

FIG. 7 is a state machine implementation of the state-table of FIG. 6;

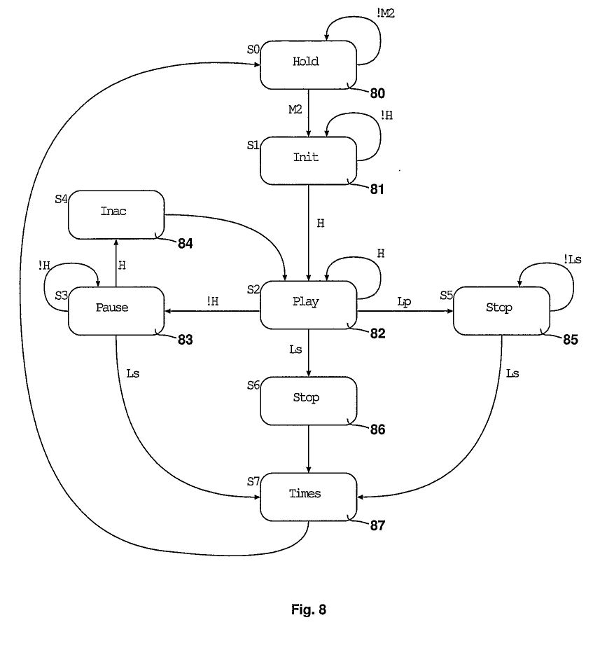

FIG. 8 is a diagram of the sequence of states of the play engine;

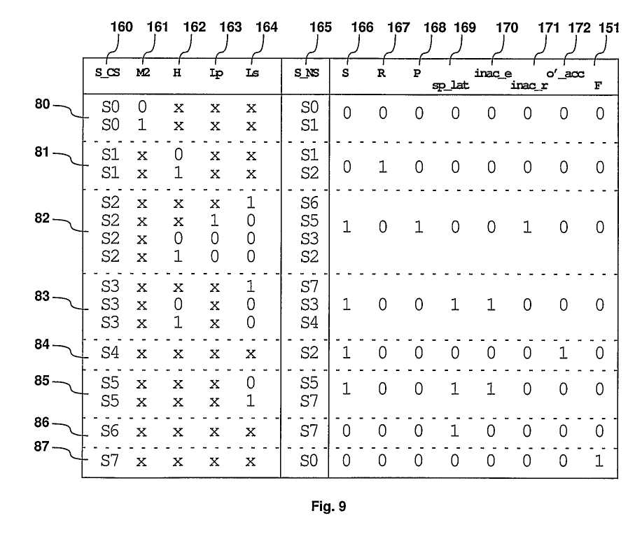

FIG. 9 is a transition table denoting the states of the play engine;

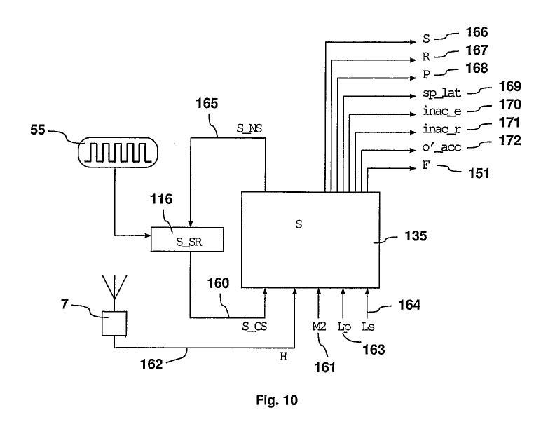

FIG. 10 is a schematic of the play engine;

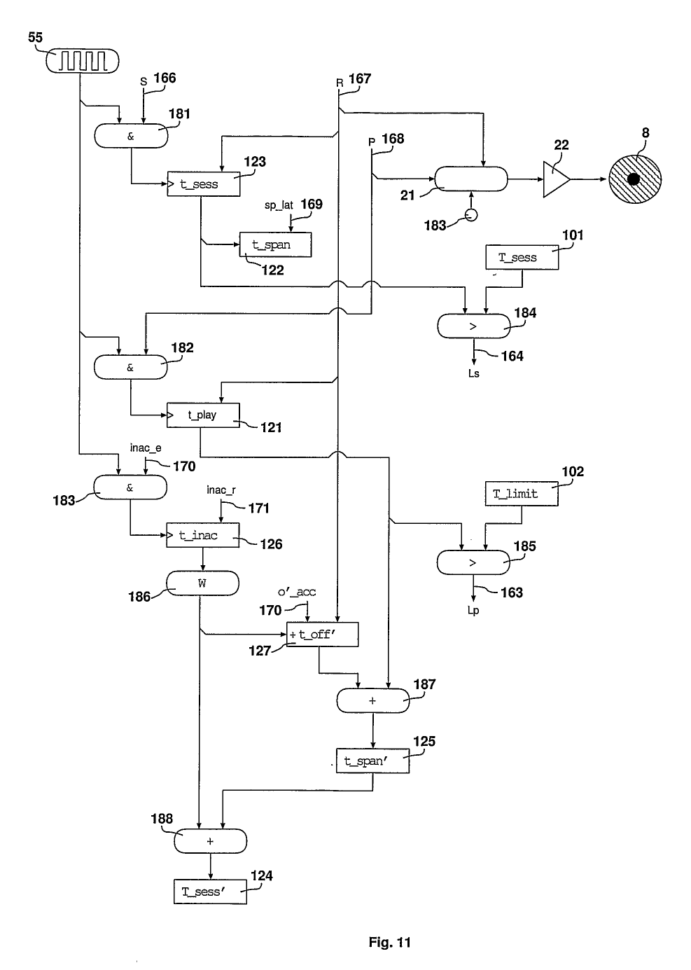

FIG. 11 shows the control logic of the play engine;

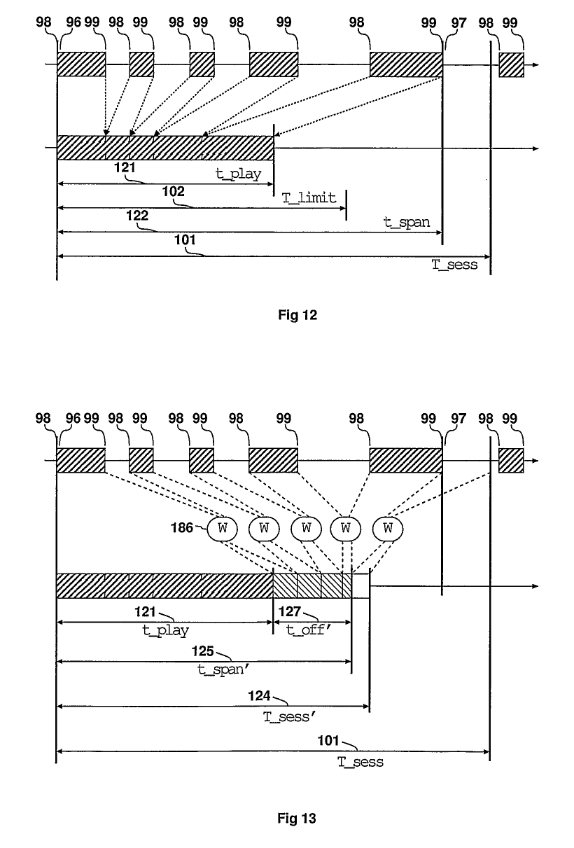

FIGS. 12 and 13 show a sequence of times measured during a play session;

FIG. 14 illustrates the calculation of a popularity measure P1;

FIG. 15 illustrates the calculation of a popularity measure P2;

FIG. 16 illustrates the calculation of a popularity measure P3; and

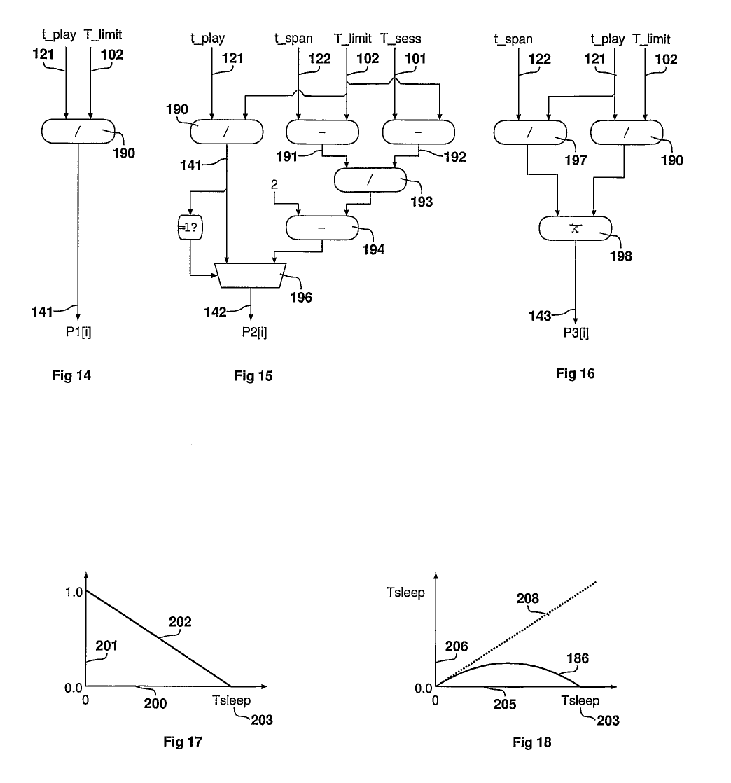

FIGS. 17 and 18 are models of probability distribution.

### OVERVIEW

We describe below a system that allows a baby to control the playback of recorded sound material while they are in a cot or crib. The interface is aimed at young babies and is of a very simple nature: when a handle is pulled sound is played, when the handle is released the sound is stopped. Grasping and pulling are reliably accomplished by babies above about four months of age.

The system extracts maximum information from the pull-handle. Based on the pattern of ON-OFF events, a measure of popularity is derived for the sound material that is currently on offer. Over time, the device builds up a database of popularities for the different types of sound material that have been played. The selection process is then biased towards sound material that is matched to the baby's own personal taste. Importantly, the system is non-habituating and adapts its output as the baby's preferences develop over time.

The system is designed to play for up to T_limit minutes of a sound recording during a session lasting up to T_sess hours. The parameter T_limit is chosen to prevent over-stimulation of the baby and a typical setting might be 45 minutes. The parameter T_sess is typically chosen to correspond to a night's sleep—for instance 8-12 hours. The same recording is repeated over a block of N sessions, each session typically coinciding with a different night. The parameter N is typically chosen to be 3 or 4, so the baby is played the same recording over a series of 3 or 4 nights. At the end of a block of sessions, a new recording is selected.

The system also provides feedback to interested parents regarding their baby's preferences, and presents an option to send the usage statistics to a central server. The usage statistics allow recommendations for new sound material to be made that are matched to the baby's specific tastes.

The system comprises two units. With reference to FIG. 1, a cot-unit 1 is mounted on the top of a cot 16 and has a pull-handle 6 hanging down. The baby 15 can pull the handle when it is lying on its back thereby activating a switch 5 which will cause a transmitter 7 to transmit a signal to the main unit 2. The cot-unit 1 is mounted on the cot 16 by means of a simple screw mechanism between the bars and supported by the top bar.

The base-unit 2 is placed in the same room as the cot 16. It contains a speaker 8, a receiver 9, an adaptive sound player 10, a USB connector 17, a volume control 18, and a flash memory card 11.

Communication 12 between the cot-unit 1 and the base-unit 2 is achieved using a low-power wireless RF link. When the baby pulls the handle 6, transmitter 7 sends a signal that is picked up by receiver 9 which causes the adaptive sound player 10 to play a pre-recorded sound on speaker 8.

If the parents own a computer 3 (a PC, Macintosh, or other O/S), then the USB-port 17 can be used with USB cable 13 to connect the base-unit 2 to the computer 3. When connected, the parents can download albums of their choice onto memory card 11, they can create a recording of their own (for example telling a story), or they can gather information about how the baby used the device. If the parents do not own a computer, the device works autonomously, as it will come preloaded with, say, 30 albums.

If the computer 3 is connected to the internet 14, the feedback can be transferred to a central server 4, where they can obtain recommendations for new albums to upload. The two units are entirely separate and disconnected in order to ensure electrical safety, and to simplify design and deployment. The base-unit can be mains powered without compromising safety. The cot-unit can be battery-powered and is designed so that the battery life exceeds the expected life of the product.

### The Cot-Unit

The cot-unit 1 consists of a plastic box, approximately 15 cm wide, 15 cm high and 20 cm deep. It is deep enough that it overhangs in the cot and gives the baby a good grip on the pull handle. It is wide enough that it spans at least two of the bars of the cot, and it is high enough so that it can deal with the baby pulling the cord forcefully and does not get in the way if the baby rolls in the cot. FIG. 1A shows a cross section of cot-unit 1. A support member 212 projects from the upper edge of the unit and rests on top of the horizontal bar (not shown) which runs along the upper edge of the cot. The unit is secured by a screw mechanism comprising an externally threaded shaft 210 and a nut 211. The shaft 210 is sufficiently narrow to pass between two adjacent vertical bars (not shown) of the cot. The nut 211 is screwed onto the shaft 210 and has a width greater than the space between two adjacent vertical bars. Thus by screwing the nut 211 onto the shaft 210, the nut engages the vertical bars to lock the unit in place.

The cot-unit 1 is shown schematically in FIG. 2. It consists of a switch 5, with a pull handle 6, a battery 19 and a micro-controller 30 with embedded transmitter 7. The micro-controller 30 is interrupted when the switch 5 changes from on to off or vice versa.

The switch 5 is a push-to-make-release-to-break (PTMRTB) type switch. The switch generates an ON signal in response to the handle 6 being pulled into an ON position, and generates an OFF signal in response to movement of the switch into an OFF position when the handle is released. It has been found that such a simple ON/OFF switch mechanism is particularly suited to operation by babies, in contrast with more complex play/stop/skip controls associated with conventional playback devices.

The signals for ON and OFF must be transferred from the cot-unit 1 to the base-unit 2. Unlike the users of conventional switches (such as a car-key or a remote control for a television or light), the baby is less able to cope with transmission errors. Hence, the switch operation must be extremely reliable, in order not to send confusing messages to the baby. At the same time, the communication should be low power. We have designed a protocol for the wireless transmission of the ON-OFF signals that requires few components, is extremely reliable, has low latency, and uses very little power.

The protocol operation is shown schematically in FIG. 3. It is based on an exponential back-off. The main-loop constitutes the transmission of the switch-state 42 followed by a sleeping period 43 which is doubled every time 44. The initial sleep-period is 31.25 ms 41, and the initial state that is transferred is OFF 40. So initially, the microcontroller will transmit an OFF state immediately and send another OFF state after 31.25 ms. Subsequent OFF packets are sent after 62.5 ms, 125 ms, 250 ms, 500 ms, 1 s, 2 s, 4 s, 8 s, . . . . When the baby pulls or releases switch 5 the sleep-operation 43 will be interrupted, and the appropriate path is chosen. If the switch is pulled, 46 will set the state to 1 (ON), the interval timer is set back to 31.25 ms 41, and an ON-packet is transmitted 42, followed by a sequence of ON-packets. When the switch is released, 45 will set the state to 0 (OFF), and OFF-packets will be transmitted.

The time of the first packet is chosen to be well below human reaction time. If the switch is pulled continuously for a 1 year period, no more than 30 packets will have been transmitted, of which 7 occur in the first two seconds. So, if the receiver misses the first ON-packet, it is very likely to receive another ON-message quickly. In between transmissions, the micro-controller 30 can power down, taking virtually no power when the switch is not changing state for a prolonged period of time, for example when the baby is asleep or during holidays.

We estimated the power consumption of the cot-unit 1 based on the use of an RF-PIC sold by Microchip. The transmission of a packet will take 4.7 mA for 10 ms at 3V, or 0.141 mWs. While sleeping, an RF-PIC will take 9 uA at 3V, or 0.027 mW, or 0.8 kWs, 0.25 Wh in a year. Two AA batteries can provide 6 Wh, which leaves 5.75 Wh for transmitting the switch packets. If the switch is pulled every two seconds for a year, it will create 16 million pulls, or 96 million packets, which requires 14.1 kWs, or 4 Wh.

### Base Unit

The base-unit is a box, approximately 10 cm high, 8 cm wide, 6 cm deep, much like a PC speaker. A schematic is shown in FIG. 4. The unit houses an adaptive sound player 10, a speaker 8, a volume control 18, an RF-receiver 9, flash memory 11 and a USB port 17. The adaptive sound player 10 comprises the device controller 20, an audio decoder 21 and an amplifier 22.

The flash memory 11 holds the album store 25 which is loaded with a number, A 112, of albums. An album is a collection of recorded sound, for example an adventure story with musical interludes, a symphony by Bach, Queen, or white noise. Each album lasts for no more than T_limit 102 minutes, and the device will store around 30 albums. The albums are stored using conventional compressed audio formats (e.g. mp3, wma, aac). For playback, a standard audio decoder chip 21 is used to convert the compressed data to an analog audio signal which can be sent, via amplifier 22, to speaker 8.

The device controller 20 forms the heart of the base-unit; it connects with the other components, controls the playback of sound material, and generates feedback 26 regarding the baby's preferences. The device controller contains memory units 100-113, 144-146 and process units 30-38. The operation of the device controller 20 may be described in terms of a finite state machine. The sequence of states is presented in FIG. 5, with a state transition table given in FIG. 6. A possible implementation of the state machine is shown in FIG. 7. This state machine is referred to as the master controller 30. The master controller 30 ensures proper sequencing and synchronization of the process units 31-37 and generates the required set of controls signals to drive the sound decoder 21.

The general flow of control is shown in FIG. 5. When switched on, the master controller will start in state M0 70. During this state, the Initialisation process 31 checks the album store 25 to see if any albums have been added or deleted, updating the play history and popularity distributions accordingly.

In the next state, M1 71, the Album Selector 32 selects a random album C 113 based on the Popularity History 111 and the Play History 110 of each album. This album is identified by a number between 0 and the number of albums A 112. This state also generates a signal, i_reset 155, which causes the session counter i 114 to be cleared.

Control then passes to state M2 72 which enables the Play Engine 33 and increments the edge-triggered session counter, i 114, by setting the i_inc signal 154. The Play Engine 33 is responsible for monitoring the ON-OFF signals that are received by the RF receiver 9, and for controlling the playback of the selected album. During the session, a set of times are measured based on the pattern of ON-OFF events that are observed. The system will remain in this state until the Play Engine 33 sets signal F 151, indicating that the current session has terminated. The set of times measured during the session are made available to the subsequent processes.

With the session over, the machine enters state M3 73. Here, the Popularity Calculator 34 derives a popularity measure P[i] 144 for the session i, based on the set of times recorded by the Play Engine 33. If session counter i 114 is less than the number of sessions per block 100 (a condition indicated by signal i<N 152) then control is passed back to state M2 72, allowing a new session to be started. However, if the session counter has reached the block limit N 100, then signal i<N 152 causes the state machine to move to state M4 74.

In state M4 74, the Summariser 35 combines the popularity measures P[1], P[2], . . . , P[N] 144, generated during the last N 152 sessions, to give a popularity rating for the block, P_b 145.

Moving to state M5 75, the Normaliser 36 adjusts the popularity rating, P_b 145, in such a way so as to compensate for the baby's own specific behavior, giving the normalised popularity rating P_n 146.

In state, M6 76, the Learner 37 updates the Popularity History 111 and Play History 110, incorporating the popularity rating P_n 146 derived from the block of sessions.

In the final state, M7 77, feedback regarding the baby's preferences is generated by the Feedback unit 38 and written to the flash memory as a set of HTML pages 26.

The system then returns to state M1 71 where a new album is selected and the next block of sessions begins.

FIG. 6 denotes the states in a state-table, indicating that given a current state 150 and the inputs F 151 and i<N 152 one calculates the next state 153 and outputs i_inc 154 and i_reset 155. An ‘x’ indicates “don't care”.

FIG. 7 shows a possible state machine implementation, comprising state control logic M 130 which implements FIG. 6, a state register 115 that provides the current state 150 to the control logic M 130 and that is latched on every clock-cycle with the next state 153. The control logic outputs signals to reset 155 or increment 154 counter i 114, which is compared to N 100 using comparator 131. The resulting signal is used to drive state logic 130 in conjunction with signal F 151.

### The Play Engine

The operation of the Play Engine 33 can be described using a finite state machine as the controller. The sequence of states is presented as a diagram in FIG. 8, and as a state transition table in FIG. 9. A schematic is given in FIG. 10, along with the accompanying control logic in FIG. 11. This state machine is referred to as the session controller.

The session controller starts in state S0 80 and remains in this state until the master controller has entered state M2 72, indicating that a new session can be started.

The session controller then moves to state S181 where a reset signal R 167 is generated. The reset signal clears session timer t_sess 123, play timer t_play 121, and compensated off-time accumulator t_off′ 127. The reset signal also directs audio decoder 21 to load the album specified by the index of the current album C 113. The decoder is positioned at the beginning of the album, but playback is not started at this stage.

The controller waits in this state, listening to the output of receiver unit 9. When handle 6 is pulled, receiver unit 9 will receive an ON-packet and set signal H 162 high. The controller will then move to state S2 82. This is the point at which the play session is considered to have started.

In state S2 82, signal S 166 is set, indicating that the session is active. This signal remains high until the end of the session has been reached. The session timer t_sess 123 counts the number of clock ticks that have elapsed since the start of the session. To this purpose, clock signal 55 is gated by unit 181 and only passed through if signal S 166 is high. State S2 82 also sets play signal P 168 and inac_r 171. Setting play signal P 168 causes the audio decoder 21 to resume playback of the album from the current position. Setting inac_r signal 171 clears the inactivity timer t_inac 126. The play timer t_play 121 counts the number of clocks ticks that elapse while the device is playing audio. This is achieved by gating clock signal 55 with play signal P 168 before being passed on to counter t_play 121. The system remains in state S2 82 until either the handle is released, or one of the time limits is reached.

If handle 6 is released, receiver unit 9 will receive an OFF-packet, and output low for signal H 162. As a result, the controller moves from state S2 82 to state S3 83. The play signal P 168 is pulled low which causes the audio decoder 21 to suspend playback, and prevents the clock ticks from reaching play timer t_play 121. Signal inac_e 170 is set, allowing timer t_inac 126 to count the number of ticks that elapse during the current period for which playback is suspended. The controller remains in this state until either the handle is pulled again, or the session timer t_sess 123 reaches the session limit T_sess 101.

If handle 6 is pulled, signal H 162 will go high and the session controller will move to state S4 84. Signal inac_e 170 is pulled low, causing gate 183 to prevent the clock signal from reaching timer t_inac 126. The value of timer t_inac 126 represents the duration of the last period of inactivity (i.e. from when the handle was released to when it was pulled). This value is passed through a time warping function W 186. With the session controller in state S4 84, the signal o′_acc 172 is set, which causes the compensated off-time accumulator t_off′ 127 to latch and add the current result of the inactive time warping function W 186. The value t_off′ 127 represents the total off-time after compensating for the periods of inactivity. The controller then returns to state S2 82 where playback resumes.

Another control path from state S2 82 occurs if the session timer t_sess 123 reaches the limit specified by the session duration T_sess 101. To this effect, comparator 184 evaluates the condition t_sess>T_sess. When the limit is reached, signal Ls 164 will go high, causing the controller to move to state S6 86.

In state S6 86, signal S 166 is pulled low, indicating the session has terminated. Play signal P 168 is also pulled low causing the audio decoder 21 to cease playback. Both timers t_sess 123 and t_play 121 are prevented from receiving clock ticks. Signal splat 169 is set high, causing span timer t_span 122 to latch the current value of session timer t_sess 123.

The controller then moves to state S7 87 where the session finished signal F 151 is set high, indicating to the master controller that the session has finished, and the values in the timers, t_play 121, t_span 122, t_span′ 125 and T_sess′ 124, may be read. Note, the values of the timers remain valid until the next session is ready to start and the session controller has entered state S1 81.

The final control path from state S2 82 occurs if the play timer t_play 121 reaches the play limit specified by T_limit 102. The comparator 185 monitors the condition t_play<T_limit, setting signal Lp 163 high when the limit has been reached. This will cause the controller to move to state S5 85.

In state S5 85, play signal P 168 is pulled low which directs the audio decoder 21 to cease playback. Signal sp_lat 169 is set high, causing the span timer t_span 122 to latch the current value of the session timer t_sess 123. The controller remains in this state until the session timer t_sess 123 reaches the session duration T_sess 101. Signal Ls 164 will go high, causing the session controller to move to state S7. As before, signal S 166 is pulled low, indicating the session has terminated, and signal F 151 is set high to inform the master controller that the session has terminated.

Similarly, while in state S3 83, an exit to state S7 87 may also occur if the session timer t_sess 123 has reached the session limit T_sess 101 and the signal Ls 164 has gone high.

The set of times measured during the play session are shown diagramatically in FIG. 12 and FIG. 13. Events 98 refer to the baby pulling handle 6, Events 99 refer to the baby releasing handle 6. Event 96 is the first pull of the handle in a session. Event 97 is the last release of the handle in the session. t_play 121 is the total period of time for which the handle was pulled. This will never be greater than T_limit 102. t_span 122 is the time from the first pull to the last release. This will always be less than, or equal to, T_sess 101.

### Popularity Calculator

The pull-handle mechanism provides a necessarily simple interface to the baby. Importantly, the way in which it operates allows the immediate association between the action of pulling the handle and the playing of the sound. As a result, the baby is quickly able to learn how to control when the sound is on, and when the sound is off. Other options lack this simplicity, either relying on the potentially confusing concept of state, or requiring multiple controls.

It is important not only that the baby has control over when the sound is played, but also that the baby likes the sound that is being played. One option, which maintains the simplicity of the interface, is for the device to analyse the baby's behavior and to make predictions regarding its preferences. The analysis may look at a variety of measures. However, in its simplest form, we just look at the pattern of ON-OFF events that are generated.

The Popularity Calculator 34 described below interprets the ON-OFF events that are generated by the switch, and derives a popularity measure P[i] 144 for the album played during the session i. We describe three possible structures for this analysis, each subsequent one more advanced.

### Pull Duration

One way to perform the analysis is to measure the total on-duration t_play 121 over a session. This is a measure that correlates well with whether the baby likes the music or not, and is independent of the age of the baby (young babies may tend to pull and release the cord many times in succession). Sound will never be played for longer than a preset time, T_limit 102, in order to avoid over stimulation (for example 45 minutes). If a baby has listened to all T_limit 102 minutes then they like this particular album. If they have listened to only two minutes then they dislike this album. We define the popularity measure P1 as the division of t_play 121 by T_limit 102:

P1[i]=t_play/T_limit

P1 61 is a number ranging from 0.0 (indicating an unpopular rating) to 1.0 (indicating a popular rating). The time periods, t_play 121 and T_limit 101, are illustrated in FIG. 12, with a possible implementation given in FIG. 14.

### Pull Duration and Time Span

The above method provides a reliable popularity rating when the album is played for less than T_limit 101 minutes. However, if the baby likes music in general, then they might listen to maximum T_limit minutes for several albums. In this situation, the period of time t_span 122 over which T_limit 102 was reached gives a further indication as to the popularity of the album; an album for which T_limit was reached in a short period of time is considered to be more popular than one that required a long period of time. Indeed, even if the limit had not been reached, the period of time over which the album was played provides additional information regarding the popularity of an album. Taking this into account, we define two possible measures, P2 and P3.

P2 is calculated as shown in FIG. 15. Assuming T_limit 102 has been reached, the difference 191 between t_span 122 and T_limit 102 is the time that the baby did not listen to the music, while it could have. The difference 192 between the T_sess 101 and T_limit 102 is the maximum time that the baby could have not listened to the music. A division 193 of these two differences gives us a number between 0.0 (very popular, the baby listened to the full album without breaks) to 1.0 (popular, the baby listened to the album with maximum breaks). Given that P1 141 generates a number between 0.0 (unpopular) and 1.0 (popular), we scale the result by subtracting it from 2. This gives a number between 1.0 (popular) and 2.0 (very popular). Combined with P1, we get:
If (t_play<T_limit)
   P2[i]=P1[i]
Else
   P2[i]=2−(t_span−T_limit)/(T_sess−T_play)

The other measure, P3, is calculated as shown in FIG. 16, by first dividing t_span 122 over t_play 121, and then taking a weighted average with P1:

P3[i]=k*P1[i]+(1−k)*(t_span/t_play)

The weight factor ‘k’ in the weighted average is a factor, between 0 and 1, that specifies the relative importance of the total time played and the time over which it was played.

### Predicting Whether the Baby is Awake or not

A more advanced method for measuring popularity is to ignore periods where the baby is asleep. We can predict whether or not the baby is asleep by measuring the contiguous time for which the handle is released. If the handle 6 was released for a short period of time, then the baby was probably awake during that period. If the handle 6 was released for a long period of time (say 6 hours), the baby was either asleep, not in the cot or not interested in listening to sound of any sort at that time; in each case, this period of time should be ignored when considering the popularity of the album. For intermediate periods of inactivity, there is a probability that the baby is awake. We model this probability, and multiply the time that the baby is not listening with this probability. As a result, short periods of inactivity will remain largely unchanged, while long periods of inactivity will effectively be ignored.

The probability distribution that governs the likelihood that a baby is awake can be estimated by monitoring the behavior of a number of babies. A simpler model is shown in FIG. 17. The X-axis 200 is the period of time that the handle was not pulled. The Y-axis 201 is the probability of the baby being awake. We assume that the relation 202 between the two reduces linearly over periods of inactivity, up to a limit, T_sleep 203, at which point sleep is assumed. As mentioned above, the duration of each period of inactivity, t_inac 126, is multiplied by the probability that the baby is asleep during that period of time, giving the effective period of inactivity t_inac′:

t_{—}inac′=W(t_{—}inac)=(T_sleep−t_{—}inac)*t_{—}inac/T_{—}sleep

This mapping is shown in FIG. 18. The X-axis 205 is the measured period of inactivity t_inac 126 and the Y-axis 206 is the time-compensated period of inactivity t_inac′. Without compensation, there would be a direct mapping 208, but with compensation we get a mapping 186 which reduces the influence of longer periods of inactivity.

The time-compensation mapping W 186 is applied to each period of inactivity observed during the session. Taking this into account, we get alternative forms for t_span and T_sess:

t_span′=t_play+t_off′

T_{—}sess′=t_play+t_off′+W(t_{—}inac)

where t_off′ 127 represents the sum of time-compensated periods of inactivity observed during the period t_span 122, and t_inac 126 represents the period of inactivity after t_span. These time measures are shown diagramatically in FIG. 13. Note, t_inac will be zero if the session terminated while the album was being played. t_play is only effected by the “ON” periods and therefore remains unchanged.

The times t_span′ and T_sess' are generated by the play engine during the course of the session. The algorithms for calculating the popularity measures P2 and P3, can be applied as before, using T_sess' and t_span′ in place of T_sess and t_span respectively. Note, P1 does take into account periods of inactivity and remains unchanged.

### Summarising Popularity Over a Block of Sessions

The popularity measures, P[1], P[2], . . . , P[N] 144, are recorded over a number of sessions, N 100. The Summariser 35 combines this data and derives a single measure that reflects the popularity of the current album over the previous block. One way to achieve this is to take the maximum of all the popularity measures, since this approach ignores unpopular outliers (which can, for example, be due to the baby not feeling well):

P_{—}b=max(P[1], P[2], . . . , P[N])

More complex measures would assign a confidence value to each session's popularity, and then calculate a weighted average based on the confidence values. The number of sessions, N 100, in a block should be chosen with care. If N is too low, no reliable statistics can be obtained as to whether a baby likes an album or not, and the baby will not learn to appreciate more complex albums. On the other hand, if N is too large, the device will not be able to respond quickly enough to the baby's preferences, resulting in the baby becoming habituated.

### Normalising the Popularity Data

The popularity rating, P_b 145, generated by the Summariser 35 is a unit-less number and has an unknown average. Indeed, each baby will exhibit a different behavior and have a different average popularity rating and standard deviation. The Normaliser 36 adjusts the popularity rating P_b 145 to give a normalised popularity P_n 146 which lies on a uniform scale and is invariant to the baby's own specific behavior.

The average popularity and the standard deviation around this average are estimated using a decaying average. The decaying factor starts off as 1, and is reduced over time to a weighing factor that is in line with how quickly children change their behaviour. We denote the number of blocks over which the average should be taken B.

The process may be described as follows:
Initial Settings:
   BiasCounter=1
   Bias=0
   StdDev=0
After each block of N sessions:

```
E = 1 / Biascounter
Bias = Bias * (1−E) + P_b * E
s = (P_b − Bias)\hat{ }2
If (BiasCounter == 1) then
    StdDev = 1
Else
    StdDev = StdDev * (1−E) + s * E
Endif
If (BiasCounter < B) then
    BiasCounter = BiasCounter + 1
Endif
P_n = (P_b − Bias)/StdDev
```

The value for B should be chosen with care. If B is too high the system is too slow to adapt to changing tastes of the baby. If B is too low, the system adapts to noise in the measurements rather than the baby's preference.

### The Learner

The device employs an adaptive selection algorithm in order to determine which album should be played next. The process is governed by two sets of statistics, both of which are distributed over the collection of available albums. The first set reflects the baby's personal preferences and can be interpreted as assigning a popularity rating for each of the albums. The second set relates to the play history for each album and indicates when the album was last played.

A weighted combination of the two sets of statistics is used to determine which album should be selected next. The baby's preferences bias the selection process towards popular albums while the play history favours those albums that haven't been played recently. Below we describe each set of statistics in turn, and the way in which they are updated by the Learner 37.

### Play History

The play history, Play_H 110, is maintained as a sorted list of albums, ordered by when the album was last played, with the most recently played album at the head of the list.

The list will have A elements. Each element of the list is assigned a value log(I), where I is the index of the element in the list, starting with index 1. Hence, the last element in the list will have a value of log(A). We then normalise these values to probabilities, by scaling them by the sum of all values. The number of the album that was played during the previous block of N sessions is given by C 113. The play history probability density function is denoted Play_H[ ] 110 and an element Play_H[x] stores the probability that x is going to be played next.

The Learner 37 updates the play history 110 as follows:
Initially:
   List is a list of indices of all albums
After each block of N sessions:

```
Remove C from List
Insert C at place 1 in List
Sum = 0
For each index I (1 ... A)
    V[I] = log(I)
    Sum = Sum + V[I]
For each index I (1 ... A) in list
    Play_H[List[I]] = V[I]/Sum
```

### Popularity History

The popularity history, Pop_H 111, is stored as a Probability Density Function (PDF). Each album has a probability assigned to it, reflecting the likelihood that the baby likes this album.

When the device is used for the first time, no prior knowledge regarding the baby's preferences is available. The PDF is simply initialised with a uniform distribution, with the result that each album will have the same chance of being selected. (Alternatively, the device can be initialised using averaged statistics derived from the data of other babies of a similar age.) During operation of the device, the PDF is adjusted in response to the baby's actions. An album's rating will increase if found to be popular and decrease if found to be unpopular.

The learner 37 tries to maintain a proper estimate for the PDF that reflects the baby's preferences. We achieve this by folding in the popularity rating P_n 146, derived by the Normaliser 36, into our PDF. This is a two step process. First, the measured popularity, P_n, is mapped onto a probability value into the PDF. Second, this value is then used to adapt the PDF. This process is explained in detail below

1. Mapping the measured popularity index onto a probability is performed by assuming that the popularity will roughly follow a normal distribution. (Strictly speaking it cannot be a normal distribution, since our timing measurements are limited.) We map a P_n value of 0 onto a probability of 1/A (where A is the number of albums, 112), we map a P_n value of −3 or below onto a probability value of 0, and a P_n value of 3 or above onto a probability value of 1. In terms of a normal distribution: −3 reflects the 0.5-percentile, and +3 reflects the 99.5-percentile.

The mapping can be done by using a linear interpolation, or one can follow the CDF (cumulative distribution function) of a normal distribution. In the example implementation below we use a linear interpolation. The PDF associated with a baby's preference is called Pop_H 111, and element Pop_H[x] denotes the relative preference of the baby for album x.

2. Folding the obtained probability into the PDF involves trying to make our PDF more consistent with the reading that we have obtained. Hence we will use a weighting factor, ‘j’, that will tell us how quickly to adapt our PDF to a reading. We establish how much bigger or smaller the probability value of the album will become, and this difference is then taken away from the probabilities of all other albums proportionally to their probability.

The weight factor ‘j’, which is a value between 0 and 1, should be chosen with care. Too high a weight factor will cause the system to forget old albums, too low a weight factor will cause the system to adapt too slowly.

Noise can be added to the system, or a minimum PDF for each album can be set, in order to prevent albums from being ‘banned’ by having a PDF value that is so close to zero that they are never picked again. This bottom value should be proportional to 1/A, for example 1/(2 Å).

### In Pseudo-Code:

For each block of N sessions:

```
If (P_n < −3) then
    mapP = 0
Elseif (P_n < 0) then
    mapP = (P_n+3)/(3*A)
Elseif (P_n < 3) then
    mapP = P_n * (1−1/A)/3 + 1/A
Else
    mapP = 1
Endif
Diff = Pop_H[C] * j + mapP *(1−j) − Pop_H[C]
For each album I (1 ... A)
    Pop_H[I] = Pop_H[I] * (1 − Diff)
Endfor
Pop_H[C] = Pop_H[C] + Diff
```

### Album Selection

The Album Selector 32 is governed by the two distributions, the play history Play_H 110 and the popularity history Pop_H 111. We first multiply the two probability functions Play_H and Pop_H. Albums that proved popular in the past and that have not been played recently end up with a higher chance of selection. Conversely, a reduced chance of selection results for un-popular albums that were played recently. This selection process also guarantees that all albums in the collection have at least some chance of being played. This is important to ensure that the system is non-habituating and that it can adapt as the baby's preferences evolve over time. Another point to note, is that the same album will never be selected in two consecutive session, since the play history for the album will assign a zero probability to the album after the first session.

We first compute the overall likelihood R of an album being played next. We then compute the sum, Sum, of all the R values. We then pick a random number between 0 and Sum, and we start subtracting the overall R of each album in turn until we reach a negative number. The previous album is the randomly selected album.

At the start of each block of N sessions:

```
For each album I (1, 2, ... , A)
    R[I] = Pop_H[I] * Play_H[I]
endFor
Sum = R[1] + R[2] + ... + R[A]
Random = random number between 0 and Sum
For each album I (1, 2, ... , A)
    If (Random < R[I]) then
        C = I; Select I to be played over this period.
        Done
    Endif
    Random = Random − R[I]
endEor
```

The selection process represents an important aspect of the overall operation of the device. The selection achieves the following criteria: the device must present albums in a non-habituating manner; the selection of albums should be in keeping with the baby's preferences; and the system should adapt as the baby's preferences evolve over time.

### Album Check

The album store 25 consists of two parts: the ‘vault’ and the ‘jukebox’. The vault stores albums that are at present hidden from the baby. The jukebox contains the albums that are being played. After each block of N sessions, an extra album gets moved from the vault to the jukebox. Initially, the vault contains all albums, and the jukebox just a single album, white noise. The repertoire of albums is gently introduced to the baby. The order in which they are being introduced can be pre-specified.

When a new album is added to the jukebox, it has to be placed in the PDF for both the play history and the baby's preference: H and L. In the play history we place the album at the tail of the list, since this album has never been played. In the baby's preference, we assign this album an ‘average’ preference value of 1/(A+1), where A is the number of albums before we inserted this new album. All other albums have their preference reduced. This process is implemented by the Initialiser 31:
When a new album gets added:

newValue = 1/(A+1)
For each album I (1 ... A)
L[I] = L[I] * (1 − Diff)
Endfor
L[A+1] = newValue
A = A + 1

### USB Connectivity

The base-unit 2 may be connected to a computer 3 that includes a USB port. The concept of a removable storage device is used to allow the device to be plugged into any computer without the need to install any “drivers”. This makes the device compatible with any computer system, whether it runs Windows-XP, 2000, ME, MacOS or Linux. Once plugged in, the parents can, get access to the feedback information, and upload additional sound material.

### Parental Feedback

Feedback regarding the baby's preferences and usage statics is maintained as a set of HTML pages 25, located on the flash memory 11. After the learner 37 has updated the play history 110 and the popularity history, the feedback process 38 updates the feedback pages to incorporate the information from the last block of sessions.

The HTML pages 25 become accessible when the device is plugged into a computer and can be viewed using any standard web-browser. The HTML pages also present the option for parents to press a button and send their baby's preference data to a central server 4. This option assumes that the computer has an active internet connection 14.

The feedback made available to the parents includes the following types of information:
Album Preferences—The popularity ratings for each album in the store.
Activity History—When and for how long the device was used during previous sessions.
Popularity History—The popularity rating of each album over the sessions.
Recommender Service—An option to receive recommendations of new sound material.

### The Recommender Service

If people have an internet connection 14, then they are given the opportunity to upload their statistics to central server 4. This server runs recommendation software (similar to that of amazon.com), which recommends albums to the parents. There are two types of recommendation: the first is based on other babies of a similar age with similar preferences, and the second is based on older babies that had similar preferences when they were at a similar age.

We plan to use a standard recommender algorithm as published in the literature.

The preferred embodiment described above offers a number of distinct advantages. Most importantly, the system offers an interface that allows young babies to control the playback of sound material. The system learns the personal preferences of the baby and employs an adaptive algorithm to select the most appropriate piece of sound material. Furthermore, the system provides feedback to interested parents regarding their baby's personal preferences. Recording the baby's usage statistics also allows a recommendation service to be offered. Finally, the two-unit design offers a low power solution, ensures electrical safety and simplifies deployment of the device. However, in a more basic version the cot-unit and base-unit may be integrated into a single cot-mounted device.

1. A method of assigning a popularity rating to a media recording, the method comprising generating a play instruction in response to movement of a switch into an ON position; starting playback of the media recording in response to the play instruction; generating a stop instruction in response to movement of the switch into an OFF position; stopping playback of the media recording in response to the stop instruction; recording a play duration indicative of the time lapse between receipt of the play instruction and receipt of the stop instruction; and assigning a popularity rating to the media recording at least partially in accordance with the play duration.

2. A method according to claim 1 further comprising selecting the media recording from a database of media recordings at least partially in accordance with a popularity rating previously assigned to the media recording.

3. A method according to claim 2 further comprising assigning a play history to the recording; and selecting the media recording from a database of media recordings at least partially in accordance with a play history of the media recording.

4. A method according to claim 3 further comprising maintaining an ordered list of the media recordings in the database, ordered by when the media recording was last played; and selecting the media recording at least partially in accordance with its position in the list.

5. A method according to claim 1 further comprising uploading the popularity rating to a remote server.

6. A method according to claim 1 further comprising displaying the popularity rating.

7. A method according to claim 1 further comprising recommending a new media recording in accordance with the popularity rating assigned to the media recording.

8. A method according to claim 1 wherein the switch is a pull-cord operated switch.

9. A method according to claim 1 wherein the switch is a cot-mounted switch.

10. A method according to claim 1 further comprising monitoring the time elapsed since receipt of the play instruction; and automatically generating the stop instruction in response to the monitored time exceeding a predetermined threshold.

11. A method of selecting and playing a media recording, the method comprising assigning play histories to two or more media recordings, the play histories recording the order in which the media recordings were last played; assigning probability values to the media recordings at least partially in accordance with their play histories; selecting one of the media recordings, the probability of selection of each recording being determined by its probability value; playing the selected media recording; and assigning a new play history to the selected media recording.

12. A method according to claim 11 wherein the play histories are assigned to the media recording by maintaining an ordered list of the two or more media recordings, ordered by when the media recording was last played; and wherein the probability values are assigned to the media recordings at least partially in accordance with their position in the list.

13. A method according to claim 11 further comprising assigning a popularity rating to the selected media recording by a method according to claim 1, and assigning a probability value to the selected media recording at least partially in accordance with its assigned popularity rating.

14. A method according to claim 11 further comprising playing the selected media recording in response to a play instruction received from a pull-cord operated switch.

15. A method according to claim 11 further comprising playing the selected media recording in response to a play instruction received from a switch mounted to a cot or crib.

16. (canceled)

17. (canceled)

18. (canceled)

19. (canceled)

20. (canceled)

21. (canceled)

22. (canceled)

23. (canceled)

24. (canceled)

25. Apparatus configured to perform a method according to claim 1.

26. (canceled)

27. A method of controlling a media player, the method comprising receiving a control instruction from a pull-cord operated switch; and transmitting a control signal over an air interface to a media player in response to receipt of the control instruction.

28. A method according to claim 27 further comprising receiving the control signal from the air interface; and playing a media recording in response to receipt of the control signal from the air interface.

29. A media player controller comprising a pull-cord operated switch for generating control instructions and an antenna for transmitting control signals over an air interface to a media player in response to receipt of control instructions from the switch.

30. A media playback system comprising a controller according to claim 29 and a media player comprising an antenna for receiving the control signals from the air interface and an output device for playing a media recording in response to receipt of the control instruction from the air interface.

31. A method of controlling a media player, the method comprising receiving a control instruction from a switch mounted to a cot or crib; and transmitting a control signal over an air interface to a media player in response to receipt of the control instruction.

32. A method according to claim 31 further comprising receiving the control instruction from the air interface; and playing a media recording in response to receipt of the control signal from the air interface.

33. A media player controller for generating control instructions; a mounting device for mounting the controller to a cot or crib; and an antenna for transmitting control signals over an air interface to a media player in response to receipt of control instructions from the controller.

34. A media player controller according to claim 33 wherein the mounting device comprises a screw mechanism.

35. A media playback system comprising a controller according to claim 33 and a media player comprising an antenna for receiving the control signals from the air interface and an output device for playing a media recording in response to receipt of the control signals from the air interface.

36. A method of controlling a media player, the method comprising generating a play instruction in response to movement of a switch into an ON position; transmitting the play instruction over an air interface to a media player; starting playback of a media recording in response to receipt of the play instruction over the air interface; generating a stop instruction in response to movement of the switch into an OFF position; transmitting the stop instruction over an air interface to the media player; and stopping playback of the media recording in response to receipt of the stop instruction over the air interface.

37. A media player controller comprising a switch having an ON position for generating a play instruction and an OFF position for generating a stop instruction; and an antenna for transmitting the play and stop instructions over an air interface to a media player.

38. Apparatus configured to perform a method according to claim 11.
